(19) United States
(12) Patent Application Publication
(10) Pub. No.: US 2014/0100331 A1
(43) Pub. Date: Apr. 10, 2014

(54) Polyalkylene Glycol Block Copolymers Containing Phosphorus Groups And Use Thereof As Emulsifiers For Emulsion Polymerization

(71) Applicant: Hendrik AHRENS, Kriftel (DE)

(72) Inventor: Hendrik AHRENS, Kriftel (DE)

(73) Assignee: CLARIANT INTERNATIONAL LTD., Muttenz (CH)

(21) Appl. No.: 14/048,832

(22) Filed: Oct. 8, 2013

(30) Foreign Application Priority Data
Oct. 9, 2012 (DE) 10 2012 019 789.6

(51) Int. Cl. C08K 5/53

(52) U.S. Cl. CPC C08K 5/53
USPC 524/711; 524/710

(57) ABSTRACT

The invention provides aqueous polymer dispersions comprising polyalkylene glycol block copolymers containing phosphorus groups of the formula (I)

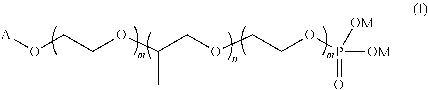

in which
A is a hydrogen atom or a phosphate group PO₃M₂,
M is a hydrogen atom or a sodium, potassium or ammonium ion,
m is a number from 1 to 100 and
n is a number from 3 to 100.

The present invention provides aqueous polymer dispersions which comprise anionic polyalkylene glycol block copolymers containing phosphorus groups and also provides for the use of such dispersions as binders for macromolecular materials of all kinds, such as fiber materials, paper stock coloring, pressure-sensitive adhesives, concrete, dry mortar mixtures, coating materials, paints, and inks, for example, and the use thereof for printing two-dimensional sheetlike structures such as paper, cardboard packaging, plastics, textiles, and leather, for example.

Aqueous polymer dispersions are prepared in accordance with the prior art by emulsion polymerization of olefinically unsaturated monomers in the presence of anionic and nonionic emulsifiers.

Customary anionic emulsifiers are sodium, potassium and ammonium salts of fatty acids, sodium alkylbenzenesulfonates, sodium alkylsulfonates, sodium olefinsulfonates, sodium polynaphthalenesulfonates, sodium dialkyl diphenyl ether disulfonates, sodium, potassium and ammonium alkylsulfates, sodium, potassium and ammonium alkylpolyethylene glycol ether sulfates, sodium, potassium and ammonium alkylphenol polyethylene glycol ether sulfates, sodium, potassium and ammonium mono- and dialkylsulfosuccinates and -monoalkylpolyoxyethylsulfosuccinates, monoesters, diesters and triesters of alkylpolyethylene glycol ether phosphoric acid, and mixtures thereof, and monoesters, diesters and triesters of alkylphenol polyethylene glycol ether phosphoric acid and mixtures thereof, and also their sodium, potassium and ammonium salts.

Nonionic emulsifiers used are customarily alkylphenol polyethylene glycol ethers, alkylpolyethylene glycol ethers, fatty acid polyethylene glycol ethers, ethylene/propylene glycol block polymers, and sorbitan ester polyethylene glycol ethers.

Emulsion polymerizations are generally carried out with whole-batch initial charge or in a feed process, in which only a small portion of the monomers to be polymerized are charged to the polymerization vessel, and the greater portion (50 to 99 wt %) is added during the progress of the polymerization. The anionic or nonionic emulsifiers are used alternatively during the emulsion polymerization in the feed or in the initial charge to the reactor, or are added subsequently to the prepared polymer dispersion, for stabilization.

The known anionic and nonionic emulsifiers control, in particular, the polymer particle size in the aqueous polymer dispersions and prevent the formation of coagulum, which may form during the polymerization reaction and lead to deposits on the reaction vessel walls and stirring mechanisms. Moreover, the known emulsifiers generally enhance the shear stability, electrolyte resistance, and freeze-thaw stability of aqueous polymer dispersions.

WO-A-99/46337 describes aqueous polymer dispersions which comprise emulsifiers containing phosphorus groups and consisting to an extent of at least 50 wt % of ethylene oxide groups and propylene oxide groups.

US-2003/100671 describes aqueous vinyl acetate/ethylene polymer dispersions, which comprise surfactants containing phosphate groups.

U.S. Pat. No. 5,416,134 describes pressure-sensitive dispersions, which comprise potassium alkylpolyethoxyphosphates as emulsifiers for acrylate polymers.

U.S. Pat. No. 6,254,985 describes pressure-sensitive dispersions, which comprise potassium alkylpolyethoxysulfates as emulsifiers for acrylate polymers.

EP-A-1077237 describes a binder preparation in which the anionic emulsifier is selected from C₁₀ to C₁₈ alkyl sulfates, the sulfates of ethoxylated C₁₀-C₂₀ alkanols having a degree of alkoxylation ≦5, and mono- and di-C₈-C₁₆ alkyl diphenyl ether disulfonates.

EP-A-0960135 describes an emulsifier system consisting inter alia of at least one salt of a sulfuric monoester of a C₉-C₁₅ alcohol or of an alkoxylated C₉-C₁₅ alcohol and the use thereof as an emulsifier system for producing an aqueous polymer dispersion by radical emulsion polymerization.

EP-A-0037150 describes aqueous polymer dispersions which comprise nonionic emulsifiers having 60 to 400 ethylene oxide groups.

DE-A-10332527 describes aqueous polymer dispersions prepared in the presence of alkylene oxide copolymers.

Used more particularly as anionic emulsifiers are sodium, potassium and ammonium alkyl polyethylene glycol ether sulfates of synthetic and natural, linear and branched, saturated and unsaturated C₈ to C₁₈ alcohols with 1 to 50 ethylene oxide groups. This group of anionic emulsifiers is very suitable for control of the polymer particle size, thus giving very fine polymer particles, and they very effectively prevent the coagulation of the polymer particles during emulsion polymerization. Additionally, alkylpolyethylene glycol ether phosphoric acid esters, the monoesters and diesters thereof, mixtures of the monoesters and diesters in acidic form and their sodium, potassium and ammonium salts with C₈ to C₁₈ alcohols, having 1 to 50 ethylene oxide groups, are suitable, along with their analogous sulfuric monoesters, for control of particle size and the prevention of coagulation.

A disadvantage of the known aqueous polymer dispersions comprising anionic and nonionic emulsifiers, however, is the often low color-strength yield obtained if the aqueous polymer dispersions are used as pigment binders for aqueous emulsion paints. Especially when the white emulsion paints produced using aqueous polymer dispersions are colored using tinting pastes which comprise organic pigments, the color strength yield is often not optimal. Too low a color-strength yield necessitates a higher level of addition of the color pastes and of the organic pigments they contain, and this is uneconomic. The skilled person is therefore looking for suitable solutions for increasing the color-strength yield for the same level of use of the tinting pastes of the organic pigments.

Also known as emulsifiers in the prior art are sulfuric monoesters of polyalkylene glycol block copolymers, which when used already generally produce a very good color-strength yield. One sulfuric monoester from this group is Emulsogen® PF 20 S, which is described and recommended as an emulsifier for emulsion polymerization in the March 1999 Clariant publication “Emulsifiers, protective colloids, defoamers for emulsion polymerization”. Emulsogen PF 20 S is a polyalkylene glycol ether sulfate ammonium salt. Sulfuric monoesters of polyalkylene glycol block copolymers are obtained by reacting ethylene oxide/propylene oxide block polymers with amidosulfonic acid, the sulfuric monoesters taking the form of ammonium salt. An alternative preparation of the sulfuric monoesters proceeds by reacting the ethylene oxide/propylene oxide block copolymers with sulfur trioxide and then neutralizing the products using aqueous sodium or potassium hydroxide solution or ammonia. Another alternative preparation of the sulfuric monoesters proceeds by reacting the ethylene oxide/propylene oxide block copolymers with chlorosulfonic acid and then neutralizing the product using aqueous sodium or potassium hydroxide solution or ammonia solution. The sulfuric monoesters of the polyalkylene glycol block copolymers typically contain in the core a polypropylene glycol chain having 3 to 100 propylene oxide units and terminal polyethylene glycol chains having 1 to 100 ethylene oxide units.

A disadvantage of the sulfuric monoesters prepared using amidosulfonic acid is that they are obtained in the form of their ammonium salts. Potassium and sodium salt can only be obtained at cost and inconvenience, by ion exchange. The synthesis with sulfur trioxide may result in a high level of free sulfuric acid and, moreover, is tied to a continuous process, making the production of small product quantities uneconomic. The synthesis using chlorosulfonic acid leads to organohalogen byproducts.

An object of the present invention, therefore, was to find new emulsifiers for emulsion polymerization that allow a high polymer dispersion solids content and achieve a high color strength of the emulsion paints produced with the polymer dispersions of the invention and tinted using color pastes.

A further object of the present invention was to find new emulsifiers for emulsion polymerization that are free from alkylphenols, alkylphenol ethoxylates, nitrogen atoms and ammonium ions, and that have a relatively low electrolyte content, which ought also to be suitable for use in anticorrosion paints.

A further object of the present invention was to find emulsifiers for emulsion polymerization that do not require labeling in accordance with European Regulation 2008/1272/EC.

Surprisingly, it has been found that this object is achieved by aqueous polymer dispersions which comprise polyalkylene glycol block copolymers containing phosphorus groups, of the formula (I), in combination with nonionic surfactants.

The invention accordingly provides aqueous polymer dispersions comprising
(A) 1.0 to 70.0 wt % of a polymer composed of at least one olefinically unsaturated monomer and prepared by emulsion polymerization,
(B) 0.01 to 7.0 wt % of at least one polyalkylene glycol block copolymer of the formula (I)

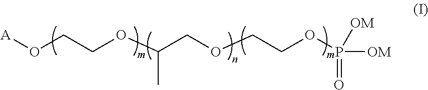

in which
A is a hydrogen atom or a phosphate group —PO₃M₂,
M is a hydrogen atom or a sodium, potassium or ammonium ion,
m is a number from 1 to 100 and
n is a number from 3 to 100, and
(E) water.

The aqueous polymer dispersions of the invention may further optionally comprise one of more of the constituents
(C) 0, preferably 0.01 to 5.0 wt %, of a nonionic surfactant, and
(D) 0, preferably 0.01-10.0 wt %, of further auxiliaries customary for the preparation of aqueous polymer dispersions, such as additional wetting agents, protective colloids, solvents, defoamers, preservatives, buffer substances, and pH regulators.

The aqueous polymer dispersions of the invention are stable to shearing, resistant to drying up, stable in storage, exhibit little or no foaming in application, and possess an outstanding rheology.

The invention additionally provides a process for emulsion polymerization, involving reacting 1.0 to 70.0 wt % of at least one olefinically unsaturated monomer by means of radical polymerization in the presence of 0.01 to 5.0 wt % of at least one polyalkylene glycol block copolymer of the formula (I), water, and optionally 0 to 5.0 wt % of a nonionic surfactant.

The invention additionally provides for the use of phosphoric esters of the formula (I) in acidic form for the emulsion polymerization and the neutralization of the phosphoric esters after the emulsion polymerization procedure with a suitable neutralizing agent. Phosphoric esters of the formula (I) have the advantage over sulfuric monoesters that they are present in the form of the free acid and thus have a lower electrolyte content. Phosphoric esters additionally have the advantage over sulfuric monoesters that they are highly suitable for aqueous anticorrosion paints.

The invention further provides for the use of aqueous polymer dispersions of the invention as pigment binders for producing formulations comprising at least one inorganic or organic pigment.

In one preferred embodiment the proportion of water is ad 100 wt %.

Preferred olefinically unsaturated monomers are for example
vinyl monomers, such as carboxylic esters of vinyl alcohol, examples being vinyl acetate, vinyl propionate, vinyl ethers of isononanoic acid or of isodecanoic acid, which are also referred to as C₉ and C₁₀ Versatic acids,
aryl-substituted olefins, such as styrene and stilbene,
olefinically unsaturated carboxylic esters, such as methyl acrylate, ethyl acrylate, propyl acrylate, n-butyl acrylate, isobutyl acrylate, pentyl acrylate, hexyl acrylate, 2-ethylhexyl acrylate, tridecyl acrylate, stearyl acrylate, hydroxyethyl acrylate, hydroxypropyl acrylate, and also the corresponding methacrylic esters,
olefinically unsaturated dicarboxylic esters, such as dimethyl maleate, diethyl maleate, dipropyl maleate, dibutyl maleate, dipentyl maleate, dihexyl maleate and di-2-ethylhexyl maleate,
olefinically unsaturated carboxylic acids and dicarboxylic acids, such as acrylic acid, methacrylic acid, itaconic acid, maleic acid and fumaric acid and their sodium, potassium and ammonium salts,
olefinically unsaturated sulfonic acids and phosphonic acids and their alkali metal and ammonium salts, such as vinylsulfonic acid, vinylphosphonic acid, acrylamidomethylpropanesulfonic acid and their alkali metal salts and ammonium, alkylammonium, and hydroxyalkylammonium salts, allylsulfonic acid and its alkali metal and ammonium salts, acryloyloxyethylphosphonic acid and its ammonium and alkali metal salts, and also the corresponding methacrylic acid derivatives,
olefinically unsaturated amines, ammonium salts, nitriles and amides, such as dimethylaminoethyl acrylate, acryloyloxyethyltrimethylammonium halides, acrylonitrile, acrylamide, methacrylamide, N-methylacrylamide, N-ethylacrylamide, N-propylacrylamide, N-methylolacrylamide, and also the corresponding methacrylic acid derivatives and vinylmethylacetamide.

In one preferred embodiment the abovementioned monomers are polymerized with further comonomers, preferably olefins or halogenated olefins having 2 to 8 carbon atoms, such as ethylene, propene, butenes, pentenes, 1,3-butadiene, chloroprene, vinyl chloride, vinylidene chloride, vinylidene fluoride and tetrafluoroethylene, for example.

The polymer dispersions are prepared by finely dispersing the water-immiscible monomers in the form of micelles in the aqueous phase, generally with the aid of component (B) and optionally of component (C), and starting the radical polymerization reaction by means of initiators such as ammonium, sodium, and potassium peroxodisulfates, for example. Alternatively it is also possible for redox initiators to be used.

Component (B) are phosphoric esters of polyalkylene glycol block polymers, which are preparable by reaction of ethylene oxide/propylene oxide block copolymers with a phosphating reagent. Suitable ethylene oxide/propylene oxide block copolymers are prepared by stepwise alkoxylation of propylene glycol, dipropylene glycol, tripropylene glycol or polypropylene glycol having a molecular weight of 300 to 500 g/mol. In this reaction, first propylene oxide in the desired amount is added onto the starting molecule under alkaline conditions, and then the desired amount of ethylene oxide, to form an ABA block copolymer consisting in the core of a polypropylene glycol chain and of terminal polyethylene glycol chains. Alkaline catalysts may be potassium hydroxide, sodium hydroxide or calcium hydroxide, which after the polyaddition has taken place are neutralized using low molecular mass organic acids such as, for example, acetic acid, propionic acid, lactic acid or longer-chain C₆ to C₁₂ carboxylic acids.

Suitable synthesis techniques for the phosphating reaction of the polyalkylene glycol block polymers use orthophosphoric acid, polyphosphoric acid, phosphorus pentoxide or phosphoryl chloride as phosphating reagent. The resultant polyalkylene glycol block copolymers containing phosphorus groups are generally present in the form of mixtures, with the polyalkylene glycol block copolymers possibly comprising one or two phosphoric acid groups, but also unreacted polyalkylene glycol block copolymers, and the phosphate groups possibly being present as monoesters, diesters and triesters. Depending on the phosphating reagent and the molar ratio used of the polyalkylene glycol block copolymers to the phosphating reagent, polyalkylene glycol block copolymers containing phosphorus groups are produced that have different compositions.

The component (C) are nonionic surfactants, preferably selected from the group consisting of fatty alcohol ethoxylates, di- and tristyrylphenol ethoxylates, fatty acid ethoxylates, esters of polyethylene glycols with fatty acids, fatty acid alkanolamide ethoxylates, EO/PO block copolymers, fatty alcohol EO/PO adducts, and also endgroup-capped fatty alcohol ethoxylates. Mixed alkoxylates may have either random or blockwise alkoxylation, unless otherwise described hereinafter.

Alcohols suitable for preparing the fatty alcohol ethoxylates are fatty alcohols having 8 to 22 carbon atoms and being of natural origin such as octyl alcohol, decyl alcohol, lauryl alcohol, myristyl alcohol, cetyl alcohol, palmitinol, stearyl alcohol, eicosanol, behenyl alcohol, oleyl alcohol, linolyl alcohol, linolenol, ricinolyl alcohol, or mixtures of C₈- to C₂₂ chain fractions, such as, for example, coconut fatty alcohol and palm kernel oil alcohol. Also suitable are synthetic primary alcohols such as iso-C₁₃ oxo-process alcohols, C₁₃/C₁₅ oxo-process alcohols, mixtures of linear, singly branched or plurally branched oxo-process alcohols having an average C chain length of 10 to 15 carbon atoms, Ziegler alcohols having 8 to 22 carbon atoms and Guerbet alcohols having 10, 12, 14, 16 or 18 carbon atoms and linear and branched, secondary alkanols having 6 to 22 carbon atoms. The alcohols used may be in saturated and unsaturated forms. The fatty alcohols are reacted in a conventional way, with the aid of alkaline or acidic catalysts, with ethylene oxide. The average degree of ethoxylation of the alcohols is 1 to 200 mol of ethylene oxide, preferably 5 to 100, and more preferably 10 to 40 mol of ethylene oxide.

In a similar way, di- and tristyrylphenol ethoxylates as well are prepared from di- and tristyrylphenol, it being possible for the alcohols to take the form of mixtures of mono-, di-, and tristyrylphenol and for the average degree of substitution to be from 2 to 3 1-phenylethyl units.

Suitable fatty acid ethoxylates are reaction products of ethylene oxide with natural and synthetic fatty acids, which have been reacted with 1 to 200 mol of ethylene oxide, preferably 5 to 100, and more preferably 10 to 40 mol of ethylene oxide.

Further fatty acid derivatives suitable for reaction with ethylene oxide are fatty acid sorbitan esters, castor oil, fatty acid glycerol esters, fatty acid polyglycerol esters and fatty acid ethanolamides. Suitable fatty acids for preparing the fatty acid derivatives are capric acid, lauric acid, myristic acid, palmitic acids, margaric acid, stearic acid, arachidic acid, behenic acid, palmitoleic acid, oleic acid and naturally occurring mixtures such as palm kernel oil fatty acid, rapeseed oil fatty acid, sunflower oil fatty acid, soya oil fatty acid, or resin acids, such as tall oil fatty acid. The fatty acids used as raw material may be in saturated and unsaturated forms.

Further nonionic surfactants suitable as component (C) are ethylene oxide/propylene oxide block copolymers having an average molecular weight of preferably 1000 to 10000 g/mol and an ethylene oxide content of preferably 10 to 99 wt % in the molecule. The ethylene oxide/propylene oxide block copolymers are prepared by adding ethylene oxide onto polypropylene glycol or by adding propylene oxide onto polyethylene glycol.

Further nonionic surfactants suitable as component (C) are fatty alcohol EO/PO adducts and endgroup-capped fatty alcohol ethoxylates. Suitable fatty alcohol EO/PO adducts are prepared by blockwise addition of ethylene oxide and propylene oxide onto fatty alcohols. The fatty alcohols are subjected to addition reaction either first with ethylene oxide and then with propylene oxide or, in the opposite order, first with propylene oxide, and subsequently with ethylene oxide.

Suitable endgroup-capped fatty alcohol ethoxylates are reaction products of fatty alcohol ethoxylates with alkyl halides, such as methyl chloride, ethyl chloride and n-butyl chloride, for example.

Component (D) are further auxiliaries, customary for the production of aqueous polymer dispersions, such as additional wetting agents, protective colloids, solvents, defoamers, preservatives, buffer substances and pH regulators.

Additional wetting agents may be wetting agents based on polysiloxane ethers, examples being a methoxypolyethoxypropyltrisiloxane, alkynediol ethoxylates and fluorosurfactants.

Protective colloids may be cellulose ethers such as carboxymethylcellulose, hydroxyethylcellulose, methylhydroxypropylcellulose, and allyl-group-modified hydroxyethylcellulose, and also partly and fully hydrolyzed polyvinyl alcohol, and polyvinylpyrrolidone.

Suitable solvents improve the freeze-thaw stability and are preferably glycol ethers, by which here are meant compounds of ethoxy and/or propoxy groups, and having average molar masses of between 200 and 20000 g/mol, more particularly polyethylene glycol ethers or polypropylene glycol ethers having an average molar mass of between 200 and 20000 g/mol, mono-, di-, or triethylene glycol, mono-, di- or tripropylene glycol, methyl-, ethyl-, propyl-, butyl- or higher alkyl-polyalkylene glycol ethers having 1, 2, 3 or more ethylene glycol units or propylene glycol units, such as, for example, methoxypropanol, dipropylene glycol monomethyl ether, tripropylene glycol monomethyl ether, ethylene glycol monobutyl ether, diethylene glycol monobutyl ether, butylpolyethylene glycol ethers, propylpolyethylene glycol ethers, ethylpolyethylene glycol ethers, methylpolyethylene glycol ethers, dimethylpolyethylene glycol ethers, dimethylpolypropylene glycol ethers, glycerol ethoxylates having a molecular weight of 200 to 20000 g/mol, pentaerythritol alkoxylates having a molecular weight of 200 to 20000 g/mol, or further ethoxylation and alkoxylation products, and random or block copolymers prepared by addition reaction of ethylene oxide and/or propylene oxides onto monohydric and polyhydric alcohols, said copolymers having a molecular weight of 200 to 20000 g/mol.

Molecular weight data for polymers always refer to their number-average molecular weight, unless indicated otherwise in a specific case. Molecular weights can be determined by GPC against polyethylene glycol as standard.

Suitable defoamers are preferably mineral oil defoamers and the emulsions thereof, silicone oil defoamers and silicone oil emulsions, polyalkylene glycols, polyalkylene glycol fatty acid esters, fatty acids, polyhydric alcohols, phosphoric esters, hydrophobically modified silica, aluminum tristearate, polyethylene waxes and amide waxes.

In-can preservatives are added to stabilize the aqueous pigment preparations and to prevent the uncontrolled multiplication of bacteria, algae, and fungi. Biocides suitable as in-can preservatives are formaldehyde, formaldehyde donor compounds, methylisothiazolinone, chloromethylisothiazolinone, benzisothiazolinone, bronopol, dibromodicyanobutane and silver chloride-coated titanium dioxide.

Buffer substances and pH regulators employed are preferably organic or inorganic bases and acids. Preferred organic bases are amines, such as ethanolamine, diethanolamine, triethanolamine, N,N-dimethylethanolamine, diisopropylamine, 2-amino-2-methyl-1-propanol or dimethylaminomethylpropanol, for example. Preferred inorganic bases are sodium, potassium, and lithium hydroxides or ammonia.

An overview of common methods, surfactants, and further auxiliaries of emulsion polymerization is given by Peter A. Lovell and Mohamed S. El-Aasser, in “Emulsion Polymerization and Emulsion Polymers”, published by John Wiley and Sons, 1997.

To prepare the aqueous polymer dispersions of the invention, components (A) and (B), and optionally components (C) and (D), are charged to a reaction vessel before the polymerization reaction commences, or are added to the reaction vessel during or after the polymerization reaction.

Generally speaking, component (B) is used in amounts of 0.01 to 7, preferably of 0.1 to 5, and more preferably of 0.2 to 2 wt %.

Generally speaking, component (A) is used in amounts of 1.0 to 70.0, preferably of 5.0 to 65.0, and more preferably of 30.0 to 60.0 wt %.

Component (B) may be used both alone and in combination with other already known, prior-art anionic and nonionic emulsifiers, as have been described at the outset. The amount of the prior-art emulsifiers in that case is preferably 0.01 to 10, more particularly 0.1 to 5 and more preferably 0.2 to 4 wt %, based on the weight of the olefinically unsaturated monomers having little or no water-solubility.

The aqueous polymer dispersions of the invention exhibit low coagulum formation during and after the polymerization and an improvement in the shear, thermal and storage stability, in the freeze-thaw stability, and in electrolyte stability with respect to divalent and trivalent cations such as calcium, barium and aluminum. The aqueous polymer dispersions of the invention form films which feature low water absorption, low water whitening, and good wet and dry rub fastness qualities.

The polymer dispersions of the invention are preferably used for producing paints, including emulsion paints, dispersion-based varnishes, printing inks, examples thereof being textile, flexographic, decorative, or gravure printing inks, wallpaper inks, water-dilutable coatings, wood stains, wood preservative systems, and paints for the surface coating of articles made, for example, from metal, wood, plastic, glass, ceramic, concrete, textile material, paper, or rubber.

A particular quality of the aqueous polymer dispersions of the invention is their use for base decorating varnishes intended for coloring with aqueous tinting pastes. Aqueous tinting pastes customarily comprise chromatic pigments, which in the coloring of aqueous base decorating varnishes may tend toward agglomeration. When the tinted paints are applied by brush, roller, or spray application, there may be instances of streakiness and an inconsistent color outcome as a result of differences in shade, because the pigments in the paint, and during the drying process, undergo flocculation, thereby reducing the color strength. When the colored paints are applied, the pigment agglomerates are separated again, but to different extents, and so the observed differences in shade occur. In the laboratory this phenomenon is simulated in the rubout test, which is described in U.S. Pat. No. 3,840,383. The aqueous polymer dispersions of the invention can be used for base decorating varnishes which are highly compatible with customary aqueous tinting pastes, do not exhibit rubout when the tinted paints are applied, and exhibit high color strength of the chromatic pigments used.

Customary aqueous tinting pastes may comprise organic or inorganic chromatic pigments.

An exemplary selection of particularly preferred organic pigments includes carbon black pigments, such as gas blacks or furnace blacks, for example; monoazo and disazo pigments, more particularly the Colour Index pigments Pigment Yellow 1, Pigment Yellow 3, Pigment Yellow 12, Pigment Yellow 13, Pigment Yellow 14, Pigment Yellow 16, Pigment Yellow 17, Pigment Yellow 73, Pigment Yellow 74, Pigment Yellow 81, Pigment Yellow 83, Pigment Yellow 87, Pigment Yellow 97, Pigment Yellow 111, Pigment Yellow 126, Pigment Yellow 127, Pigment Yellow 128, Pigment Yellow 155, Pigment Yellow 174, Pigment Yellow 176, Pigment Yellow 191, Pigment Yellow 213, Pigment Yellow 214, Pigment Red 38, Pigment Red 144, Pigment Red 214, Pigment Red 242, Pigment Red 262, Pigment Red 266, Pigment Red 269, Pigment Red 274, Pigment Orange 13, Pigment Orange 34, or Pigment Brown 41; β-naphthol pigments and naphthol AS pigments, more particularly the Colour Index pigments Pigment Red 2, Pigment Red 3, Pigment Red 4, Pigment Red 5, Pigment Red 9, Pigment Red 12, Pigment Red 14, Pigment Red 53:1, Pigment Red 112, Pigment Red 146, Pigment Red 147, Pigment Red 170, Pigment Red 184, Pigment Red 187, Pigment Red 188, Pigment Red 210, Pigment Red 247, Pigment Red 253, Pigment Red 254, Pigment Red 256, Pigment Orange 5, Pigment Orange 38 or Pigment Brown 1; laked azo and metal-complex pigments, more particularly the Colour Index pigments Pigment Red 48:2, Pigment Red 48:3, Pigment Red 48:4, Pigment Red 57:1, Pigment Red 257, Pigment Orange 68 or Pigment Orange 70; benzimidazoline pigments, more particularly the Colour Index pigments Pigment Yellow 120, Pigment Yellow 151, Pigment Yellow 154, Pigment Yellow 175, Pigment Yellow 180, Pigment Yellow 181, Pigment Yellow 194, Pigment Red 175, Pigment Red 176, Pigment Red 185, Pigment Red 208, Pigment Violet 32, Pigment Orange 36, Pigment Orange 62, Pigment Orange 72, or Pigment Brown 25; isoindolinone and isoindoline pigments, more particularly the Colour Index pigments Pigment Yellow 139 or Pigment Yellow 173; phthalocyanine pigments, more particularly the Colour Index pigments Pigment Blue 15, Pigment Blue 15:1, Pigment Blue 15:2, Pigment Blue 15:3, Pigment Blue 15:4, Pigment Blue 15:6, Pigment Blue 16, Pigment Green 7, or Pigment Green 36; anthanthrone, anthraquinone, quinacridone, dioxazine, indanthrone, perylene, perinone and thioindigo pigments, more particularly the Colour Index pigments Pigment Yellow 196, Pigment Red 122, Pigment Red 149, Pigment Red 168, Pigment Red 177, Pigment Red 179, Pigment Red 181, Pigment Red 207, Pigment Red 209, Pigment Red 263, Pigment Blue 60, Pigment Violet 19, Pigment Violet 23, or Pigment Orange 43; triarylcarbonium pigments, more particularly the Colour Index pigments Pigment Red 169, Pigment Blue 56, or Pigment Blue 61.

Suitable inorganic pigments are, for example, iron oxides, magnetites, manganese iron oxides, chromium oxides, ultramarine, nickel or chromium antimony titanium oxides, manganese titanium rutiles, cobalt oxides, mixed oxides of cobalt and aluminum, rutile mixed phase pigments, rare earth sulfides, spinels of cobalt with nickel and zinc, spinels based on iron and chromium with copper, zinc, and manganese, bismuth vanadates, and extender pigments. Used more particularly are the Colour Index pigments Pigment Yellow 184, Pigment Yellow 53, Pigment Yellow 42, Pigment Yellow Brown 24, Pigment Red 101, Pigment Blue 28, Pigment Blue 36, Pigment Green 50, Pigment Green 17, Pigment Black 11, Pigment Black 33, and Pigment White 6. Also frequently used with preference are mixtures of inorganic pigments. Mixtures of organic with inorganic pigments are likewise frequently used.

Percentages stand for weight percentages, unless otherwise indicated.

### EXAMPLES

Aqueous polymer dispersions are prepared by the emulsion polymerization process, using anionic and nonionic emulsifiers. The aqueous polymer dispersions obtained are then tested for their physical and chemical properties and used for the formulation of a white emulsion paint. Three different tinting pastes (blue, violet, black) are used to tint the white emulsion paints, which are used for paint drawdowns. The paint drawdowns are assessed coloristically.

Testing of the polymer dispersions

| | |
|---|---|
| Solids content | about 7-9 g of the aqueous polymer dispersion are weighed out |
| | into an aluminum boat. The boat is dried in a drying cabinet at |
| | 105° C. for 3 hours. After cooling in a desiccator, the boat is |
| | weighed again and the solids content is determined |
| | gravimetrically. |
| Coagulum | The entire polymer dispersion is filtered through a 100 μm sieve |
| | and subsequently through a 40 μm sieve. To accelerate the |
| | filtration procedure, a water jet vacuum is applied to the suction |
| | filter. Both filters are dried and the residue determined |
| | gravimetrically. |
| Particle size | The particle size of the polymer dispersion is determined by the |
| | dynamic light scattering method, using a Malvern Zetasizer |
| | particle size measuring instrument. |
| Viscosity | The viscosity of the aqueous polymer dispersion is measured |
| | using a Bohlin viscometer at a shear rate of 1/10 sec⁻¹. |
| Freeze-thaw stability | The aqueous polymer dispersion is stored at −18° C. for 24 hours |
| | and then thawed at 25° C. If, after thawing, the polymer |
| | dispersion forms a liquid, homogeneous dispersion again, the |
| | procedure is carried out a total of 5 times. |
| Storage stability test | The polymer dispersion is stored at 60° C. for a week and, after |
| | cooling, is subjected to visual assessment. |
| Electrolyte stability | 52 g of a polymeric dispersion are introduced into a 250 ml |
| | glass beaker and 52 g of a 5% strength CaCl₂ solution are |
| | added cautiously with stirring. Immediately after the complete |
| | addition of the CaCl₂ solution, the mixture is inspected for |
| | formation of coagulum, and again after 24 hours. If the polymer |
| | dispersion undergoes flocculation, it is not stable toward |
| | electrolytes. |

Formulation of the white emulsion paints

| | | | in |
|---|---|---|---|
| No. | Component | Composition/property | wt % |
| 1 | Water | | 18.1 |
| 2 | Tylose ® MH 10000 YP2, | Cellulose ether, thickener | 0.2 |
| | SE Tylose | | |
| 3 | Mowiplus ® XW 330, | Dispersant for inorganic | 0.3 |
| | Celanese | pigments | |
| 4 | D-Foam-R C 113, Clariant | Mineral oil defoamer | 0.2 |
| 5 | Kronos ® 2160 titanium | Titanium dioxide, white | 20.0 |
| | dioxides, Kronos | pigment | |
| 6 | Omyacarb ® 5 GU, Omya | Calcium carbonate, filler | 20.0 |
| 7 | Ammonia solution (25% | Alkalization | 0.2 |
| | strength) | | |
| 8 | Aqueous polymer dispersion | Binder | 40.0 |
| | from examples | | |
| 9 | Tafigel ® PUR 40, Munzing, | Urethane thickener | 0.4 |
| | 1:9 in water | | |
| 10 | Nipacide ® BIT 10 W, Clariant | Benzisothiazolinone, | 0.2 |
| | | biocide | |
| | Total | | 100 |

Components 1-4 are introduced and mixed with a dissolver disk, and then components 5 and 6 are dispersed to form a pigment dispersion at high stirrer speeds (laboratory dissolver at 3000 rpm). The components 7-10 are then added with less rapid stirring (laboratory dissolver at 500 rpm). For the white emulsion paints, the external form is assessed and the viscosity is determined at a shear rate of 1/60 sec⁻¹, using a Haake cone-plate viscometer.

### Tinting of the Emulsion Paints

To produce a defined shade, tinting pastes are added to the white emulsion paints. To test the color strength and compatibility of tinting pastes, 200 g of tinted emulsion paint, consisting of 98 wt % white emulsion paint and 2 wt % a blue pigment paste, are placed in a metal canister and homogenized for 60 seconds in an Inkshaker 500 from Olbrich Know How, Hemer. The compositions of the tinting pastes used are as follows.

Blue pigment paste

| | | | in |
|---|---|---|---|
| No. | Component | Composition/property | wt % |
| 1 | Water | | 32.8 |
| 2 | Dispersogen ® PTS, Clariant | Dispersant | 6.7 |
| 3 | D-Foam-R C 740, Clariant | Silicone oil defoamer | 0.3 |
| 4 | Nipacide ® BSM, Clariant | Benzisothiazolinone, | 0.2 |
| | | biocide | |
| 5 | Polyglycol G 300, Clariant | Moisture retainer | 10.0 |
| 6 | Hostaperm ® Blue B2G, Clariant | Phthalocyanine | 50.0 |
| | | pigment, Colour Index | |
| | | PB 15:3 | |
| | Total | | 100.0 |

Violet pigment paste

| No. | Component | Composition/property | in wt % |
|---|---|---|---|
| 1 | Water | | 52.8 |
| 2 | Dispersogen ® PTS, Clariant | Dispersant | 6.7 |
| 3 | D-Foam-R C 740, Clariant | Silicone oil defoamer | 0.3 |
| 4 | Nipacide ® BSM, Clariant | Benzisothiazolinone, | 0.2 |
| | | biocide | |
| 5 | Polyglycol G 300, Clariant | Moisture retainer | 10.0 |
| 6 | Hostaperm ® Violet RL 02, | Triphenodioxazine | 30.0 |
| | Clariant | pigment, Colour Index | |
| | | PV 23 | |
| | Total | | 100.0 |

Black pigment paste

| No. | Component | Composition/property | in wt % |
|---|---|---|---|
| 1 | Water | | 39.5 |
| 2 | Dispersogen ® PTS, Clariant | Dispersant | 10.0 |
| 3 | D-Foam-R C 740, Clariant | Silicone oil defoamer | 0.3 |
| 4 | Nipacide ® BSM, Clariant | Benzisothiazolinone, | 0.2 |
| | | biocide | |
| 5 | Polyglycol G 300, Clariant | Moisture retainer | 10.0 |
| 6 | Spezial Schwarz 4, Evonik | Carbon black pigment, | 40.0 |
| | | Colour Index PBk 7 | |
| | Total | | 100.0 |

To determine the color strength and the compatibility of the color pastes in the white emulsion paint, the tinted emulsion paints are coated out after one day on a test card, using a 120 μm coating bar in an Erichsen GmbH, Hemer, 509 MC film-drawing apparatus. After 7 minutes, the rubout test is carried out on the drying paint film, in the manner described in the specification U.S. Pat. No. 3,840,383. The colorimetric values of the fully dried film are determined after 24 hours using a Konica-Minolta CM 3600 spectrophotometer.

### Example 1

### Comparative Example

### Styrene/Acrylate Polymer Dispersions

1060 g of a monomer emulsion consisting of the following components are prepared by addition to a glass vessel and with stirring.

| | |
|---|---|
| 215.4 g | fully demineralized water, |
| 25.0 g | a 27% strength solution of a nonylphenol polyethylene glycol |
| | ether sulfate, sodium salt with 25 ethylene oxide units |
| | (Hostapal ® BVQ 25, Clariant, prior-art |
| | emulsifier), |
| 32.1 g | a nonionic emulsifier (Emulsogen ® LCN 287, Clariant, |
| | undecylpolyethylene glycol ether with 28 ethylene oxide units, |
| | component (C)), |
| 7.5 g | acrylic acid (monomer of component (A)), |
| 15.0 g | methacrylic acid (monomer of component (A)), |
| 15.0 g | methacrylamide (monomer of component (A)), |
| 412.0 g | 2-ethylhexyl acrylate (monomer of component (A)), |
| 338.0 g | styrene (monomer of component (A)). |

In parallel an initiator solution consisting of 2.6 g of ammonium peroxodisulfate and 71.7 g of fully demineralized water is prepared. The following components are charged to a 2 liter reaction vessel:

| | |
|---|---|
| 374.0 g | fully demineralized water, and |
| 2.8 g | a 27% strength solution of a nonylphenol polyethylene glycol |
| | ether sulfate, sodium salt with 25 ethylene oxide units |
| | (Hostapal ® BVQ 25, Clariant, prior-art emulsifier). |

Under a nitrogen atmosphere and with stirring with an anchor stirrer, the emulsifier solution in the reaction vessel is heated up to 80° C. and 23.0 g of the monomer emulsion and 14.9 g of the initiator solution are added. As soon as the radical polymerization reaction begins, the temperature of the reaction mixture climbs and the heat of reaction is taken off by cooling of the reaction vessel. The remaining monomer emulsion and 29.7 g of the initiator solution are metered in over a period of 3 hours at 80° C. Then a further 29.7 g of initiator solution are added and the batch is stirred at 80° C. for an hour. The aqueous polymer dispersion obtained is cooled to 60° C., 21.4 g of a 7% strength tert-butyl hydroperoxide solution are added, and the dispersion is stirred at 60° C. for a further hour, in order for unreacted monomers to polymerize as fully as possible. For the same reason, subsequently 30.0 g of 5% strength sodium disulfite solution are metered in, followed by stirring at 60° C. for a further hour. Thereafter, the aqueous polymer dispersion is cooled and the pH is adjusted to 7-8, using 37.5 g of 10% strength sodium hydroxide solution.

Properties of the polymer dispersion

| Test | Result |
|---|---|
| Solids content | 49.9 wt % |
| Coagulum | 289 ppm |
| Particle size | 151.6 nm |
| Viscosity | 896 mPas |
| Freeze-thaw stability | Stable after 5 cycles |
| Storage stability test | Stable |
| Electrolyte stability | Stable |

Use of the polymer dispersion as pigment binder

| Test | Result |
|---|---|
| External appearance of white emulsion paint | Homogeneous, viscous, |
| | white, readily spreadable |
| | paste |
| Viscosity of white emulsion paint | 1.49 Pas |
| Color strength of blue tinted paint | 100% (set as standard) |
| Color strength of violet tinted paint | 100% (set as standard) |
| Color strength of black tinted paint | 100% (set as standard) |

### Example 2

### Comparative Example

### Styrene/Acrylate Polymer Dispersions

1060 g of a monomer emulsion consisting of the following components are prepared by addition to a glass vessel and with stirring.

| | |
|---|---|
| 215.4 g | fully demineralized water, |
| 25.0 g | a 27% strength solution of a lauryl polyethylene glycol ether |
| | sulfate, ammonium salt with 8 ethylene oxide units |
| | (Emulsogen ® LA 083, Clariant, prior-art emulsifier), |
| 32.1 g | a nonionic emulsifier (Emulsogen ® LCN 287, Clariant, |
| | undecylpolyethylene glycol ether with 28 ethylene oxide units, |
| | component (C)), |
| 7.5 g | acrylic acid (monomer of component (A)), |
| 15.0 g | methacrylic acid (monomer of component (A)), |
| 15.0 g | methacrylamide (monomer of component (A)), |
| 412.0 g | 2-ethylhexyl acrylate (monomer of component (A)), |
| 338.0 g | styrene (monomer of component (A)). |

In parallel an initiator solution consisting of 2.6 g of ammonium peroxodisulfate and 71.7 g of fully demineralized water is prepared. The following components are charged to a 2 liter reaction vessel:

| | |
|---|---|
| 374.0 g | fully demineralized water, and |
| 2.8 g | a 27% strength solution of a lauryl polyethylene glycol ether |
| | sulfate, ammonium salt with 8 ethylene oxide units |
| | (Emulsogen ® LA 083, Clariant, prior-art emulsifier). |

The aqueous polymer dispersion is prepared in the same way as in example 1. The aqueous polymer dispersion is used to formulate a white emulsion paint, which is subsequently tinted in each case with blue, violet, and black pigment pastes for the purpose of color strength determination.

Properties of the polymer dispersion

| Test | Result |
|---|---|
| Solids content | 51.8 wt % |
| Coagulum | 193 ppm |
| Particle size | 121.4 nm |
| Viscosity | 1970 mPas |
| Freeze-thaw stability | Stable after 5 cycles |
| Storage stability test | Stable |
| Electrolyte stability | Stable |

Use of the polymer dispersion as pigment binder

| Test | Result |
|---|---|
| External appearance of white | Homogeneous, viscous, |
| emulsion paint | white, readily spreadable paste |
| Viscosity of white emulsion paint | 1.22 Pas |
| Color strength of blue tinted paint | 97% (by comparison with example 1) |
| Color strength of violet tinted paint | 106% (by comparison with |
| | example 1) |
| Color strength of black tinted paint | 97% (by comparison with example 1) |

### Example 3

### Comparative Example

### Styrene/Acrylate Polymer Dispersions

1060 g of a monomer emulsion consisting of the following components are prepared by addition to a glass vessel and with stirring.

| | |
|---|---|
| 225.4 g | fully demineralized water, |
| 15.0 g | a 50% strength solution of a polyalkylene glycol ether sulfate, |
| | ammonium salt (Emulsogen ® PF 20S, Clariant, prior-art |
| | emulsifier), |
| 32.1 g | a nonionic emulsifier (Emulsogen ® LCN 287, Clariant, |
| | undecylpolyethylene glycol ether with 28 ethylene oxide units, |
| | component (C)), |
| 7.5 g | acrylic acid (monomer of component (A)), |
| 15.0 g | methacrylic acid (monomer of component (A)), |
| 15.0 g | methacrylamide (monomer of component (A)), |
| 412.0 g | 2-ethylhexyl acrylate (monomer of component (A)), |
| 338.0 g | styrene (monomer of component (A)). |

In parallel an initiator solution consisting of 2.6 g of ammonium peroxodisulfate and 71.7 g of fully demineralized water is prepared. The following components are charged to a 2 liter reaction vessel:

| | |
|---|---|
| 375.3 g | fully demineralized water, and |
| 1.5 g | a 50% strength solution of a polyalkylene glycol ether sulfate, |
| | ammonium salt (Emulsogen ® PF 20S, Clariant, |
| | prior-art emulsifier). |

The aqueous polymer dispersion is prepared in the same way as in example 1. The aqueous polymer dispersion is used to formulate a white emulsion paint, which is subsequently tinted in each case with blue, violet, and black pigment pastes for the purpose of color strength determination.

Properties of the polymer dispersion

| Test | Result |
|---|---|
| Solids content | 50.5 wt % |
| Coagulum | 92 ppm |
| Particle size | 165.9 nm |
| Viscosity | 815 mPas |
| Freeze-thaw stability | Stable after 5 cycles |
| Storage stability test | Stable |
| Electrolyte stability | Stable |

Use of the polymer dispersion as pigment binder

| Test | Result |
|---|---|
| External appearance of white | Homogeneous, viscous, white, readily |
| emulsion paint | spreadable paste |
| Viscosity of white emulsion | 1.09 Pas |
| paint | |
| Color strength of blue tinted | 114% (by comparison with example 1) |
| paint | |
| Color strength of violet tinted | 159% (by comparison with example 1) |
| paint | |
| Color strength of black tinted | 112% (by comparison with example 1) |
| paint | |

### Example 4

### Inventive Styrene/Acrylate Polymer Dispersions

1060 g of a monomer emulsion consisting of the following components are prepared by addition to a glass vessel and with stirring.

| | |
|---|---|
| 232.9 g | fully demineralized water, |
| 7.5 g | a polyalkylene glycol block copolymer of formula (I), containing |
| | phosphorus groups, with m = 66, n = 38 and M = hydrogen |
| | (component (B)), |
| 32.1 g | a nonionic emulsifier (Emulsogen ® LCN 287, |
| | Clariant, undecylpolyethylene glycol ether with 28 ethylene |
| | oxide units, component (C)), |
| 7.5 g | acrylic acid (monomer of component (A)), |
| 15.0 g | methacrylic acid (monomer of component (A)), |
| 15.0 g | methacrylamide (monomer of component (A)), |
| 412.0 g | 2-ethylhexyl acrylate (monomer of component (A)), |
| 338.0 g | styrene (monomer of component (A)). |

In parallel an initiator solution consisting of 2.6 g of ammonium peroxodisulfate and 71.7 g of fully demineralized water is prepared. The following components are charged to a 2 liter reaction vessel:

| | |
|---|---|
| 376.1 g | fully demineralized water, and |
| 0.8 g | of a polyalkylene glycol block copolymer of formula (I) |
| | containing phosphorus groups, with m = 66, n = 38 and |
| | M = hydrogen (component (B)). |

The aqueous polymer dispersion is prepared in the same way as in example 1. The aqueous polymer dispersion is used to formulate a white emulsion paint, which is subsequently tinted in each case with blue, violet and black pigment pastes for the purpose of color strength determination.

Properties of the polymer dispersion

| Test | Result |
|---|---|
| Solids content | 50.8 wt % |
| Coagulum | 97 ppm |
| Particle size | 225.0 nm |
| Viscosity | 572 mPas |
| Freeze-thaw stability | Stable after 5 cycles |
| Storage stability test | Stable |
| Electrolyte stability | Stable |

Use of the polymer dispersion as pigment binder

| Test | Result |
|---|---|
| External appearance of white | Homogeneous, viscous, white, readily |
| emulsion paint | spreadable paste |
| Viscosity of white emulsion | 1.00 Pas |
| paint | |
| Color strength of blue tinted | 116% (by comparison with example 1) |
| paint | |
| Color strength of violet tinted | 162% (by comparison with example 1) |
| paint | |
| Color strength of black tinted | 108% (by comparison with example 1) |
| paint | |

### Example 5

### Inventive Styrene/Acrylate Polymer Dispersions

1060 g of a monomer emulsion consisting of the following components are prepared by addition to a glass vessel and with stirring.

| | |
|---|---|
| 202.9 g | fully demineralized water, |
| 37.5 g | a 20% strength solution of a sodium salt of a polyalkylene |
| | glycol block copolymer of formula (I), containing phosphorus |
| | groups, with m = 66, n = 38 and M = sodium |
| | (Emulsogen ® 4133, Clariant, (component (B)), |
| 32.1 g | a nonionic emulsifier (Emulsogen ® LCN 287, |
| | Clariant, undecylpolyethylene glycol ether with 28 ethylene |
| | oxide units, component (C)), |
| 7.5 g | acrylic acid (monomer of component (A)), |
| 15.0 g | methacrylic acid (monomer of component (A)), |
| 15.0 g | methacrylamide (monomer of component (A)), |
| 412.0 g | 2-ethylhexyl acrylate (monomer of component (A)), |
| 338.0 g | styrene (monomer of component (A)). |

In parallel an initiator solution consisting of 2.6 g of ammonium peroxodisulfate and 71.7 g of fully demineralized water is prepared. The following components are charged to a 2 liter reaction vessel:

| | |
|---|---|
| 373.1 g | fully demineralized water, and |
| 3.8 g | a 20% strength solution of a sodium salt of a polyalkylene glycol |
| | block copolymer of formula (I) containing phosphorus groups, |
| | with m = 66, n = 38 and M = sodium (Emulsogen ® 4133, |
| | Clariant, (component (B)). |

The aqueous polymer dispersion is prepared in the same way as in example 1. The aqueous polymer dispersion is used to formulate a white emulsion paint, which is subsequently tinted in each case with blue, violet and black pigment pastes for the purpose of color strength determination.

Properties of the polymer dispersion

| Test | Result |
|---|---|
| Solids content | 49.9 wt % |
| Coagulum | 178 ppm |
| Particle size | 231.1 nm |
| Viscosity | 438 mPas |
| Freeze-thaw stability | Stable after 5 cycles |
| Storage stability test | Stable |
| Electrolyte stability | Stable |

Use of the polymer dispersion as pigment binder

| Test | Result |
|---|---|
| External appearance of white | Homogeneous, viscous, white, readily |
| emulsion paint | spreadable paste |
| Viscosity of white emulsion | 0.84 Pas |
| paint | |
| Color strength of blue tinted | 107% (by comparison with example 1) |
| paint | |
| Color strength of violet tinted | 148% (by comparison with example 1) |
| paint | |
| Color strength of black tinted | 103% (by comparison with example 1) |
| paint | |

### Example 6

### Inventive Styrene/Acrylate Polymer Dispersions

1060 g of a monomer emulsion consisting of the following components are prepared by addition to a glass vessel and with stirring.

| | |
|---|---|
| 221.6 g | fully demineralized water, |
| 18.8 g | a 20% strength solution of a sodium salt of a polyalkylene |
| | glycol block copolymer of formula (I), containing phosphorus |
| | groups, with m = 66, n = 38 and M = sodium (Emulsogen ® |
| | 4133, Clariant, component (B), 0.5% relative to the water- |
| | insoluble monomers instead of 1.0% as in examples 1-5), |
| 32.1 g | a nonionic emulsifier (Emulsogen ® LCN 287, Clariant, |
| | undecylpolyethylene glycol ether with 28 ethylene oxide units, |
| | component (C)), |
| 7.5 g | acrylic acid (monomer of component (A)), |
| 15.0 g | methacrylic acid (monomer of component (A)), |
| 15.0 g | methacrylamide (monomer of component (A)), |
| 412.0 g | 2-ethylhexyl acrylate (monomer of component (A)), |
| 338.0 g | styrene (monomer of component (A)). |

In parallel an initiator solution consisting of 2.6 g of ammonium peroxodisulfate and 71.7 g of fully demineralized water is prepared. The following components are charged to a 2 liter reaction vessel:

| | |
|---|---|
| 373.1 g | fully demineralized water, and |
| 3.8 g | a 20% strength solution of a sodium salt of a polyalkylene |
| | glycol block copolymer of formula (I) containing phosphorus |
| | groups, with m = 66, n = 38 and M = sodium (Emulsogen ® |
| | 4133, Clariant, (component (B)). |

The aqueous polymer dispersion is prepared in the same way as in example 1. The aqueous polymer dispersion is used to formulate a white emulsion paint, which is subsequently tinted in each case with blue, violet and black pigment pastes for the purpose of color strength determination.

Properties of the polymer dispersion

| Test | Result |
|---|---|
| Solids content | 50.0 wt % |
| Coagulum | 342 ppm |
| Particle size | 249.5 nm |
| Viscosity | 371 mPas |
| Freeze-thaw stability | Stable after 5 cycles |
| Storage stability test | Stable |
| Electrolyte stability | Stable |

Use of the polymer dispersion as pigment binder

| Test | Result |
|---|---|
| External appearance of white | Homogeneous, viscous, white, readily |
| emulsion paint | spreadable paste |
| Viscosity of white emulsion | 0.86 Pas |
| paint | |
| Color strength of blue tinted | 113% (by comparison with example 1) |
| paint | |
| Color strength of violet tinted | 148% (by comparison with example 1) |
| paint | |
| Color strength of black tinted | 113% (by comparison with example 1) |
| paint | |

1. An aqueous polymer dispersion comprising
(A) 1.0 to 70.0 wt % of a polymer composed of at least one olefinically unsaturated monomer and prepared by emulsion polymerization,
(B) 0.01 to 7 wt % of at least one polyalkylene glycol block copolymer of the formula (I) 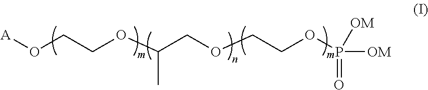
in which
A is a hydrogen atom or a phosphate group —PO₃M₂,
M is a hydrogen atom or a sodium, potassium or ammonium ion,
m is a number from 1 to 100 and
n is a number from 3 to 100, and
(E) water.

2. The aqueous polymer dispersion as claimed in claim 1, further comprising
(C) 0.01 to 5.0 wt % of at least one nonionic surfactant.

3. The aqueous polymer dispersion as claimed in claim 1, further comprising
(D) 0.01-10.0 wt % of further auxiliaries customary for the preparation of aqueous polymer dispersions, wherein the further auxiliaries are selected from the group consisting of additional wetting agents, protective colloids, solvents, defoamers, preservatives, buffer substances and pH regulators.

4. The aqueous polymer dispersion as claimed in claim 2, wherein component (C) is selected from the group consisting of fatty alcohol ethoxylates, di- and tristyrylphenol ethoxylates, fatty acid ethoxylates, esters of polyethylene glycols with fatty acids, fatty acid alkanolamide ethoxylates, EO/PO block copolymers, fatty alcohol EO/PO adducts, and endgroup-capped fatty alcohol ethoxylates.

5. The aqueous polymer dispersion as claimed in claim 2, wherein component (C) comprises ethoxylated, linear or branched, saturated or unsaturated C₈₋ to C₂₂ alcohols having 1 to 100 ethoxy groups.

6. The aqueous polymer dispersion as claimed in claim 1, having a viscosity of 10 to 10000 mPas, as determined using a cone/plate viscometer at a shear rate of 1/10 sec-1.

7. The aqueous polymer dispersion as claimed in claim 1, wherein component B is present in an amount of 0.01 to 7 wt %.

8. The aqueous polymer dispersion as claimed in claim 1, wherein component A is present in an amount of 1.0 to 70.0 wt %.

9. (canceled)

10. A pigment binder for producing formulations comprising at least one inorganic or organic pigment and at least one aqueous polymer dispersion as claimed in claim 1.

11. The aqueous polymer dispersion as claimed in claim 1, wherein component B is present in an amount of 0.1 to 5 wt %.

12. The aqueous polymer dispersion as claimed in claim 1, wherein component B is present in an amount of 0.2 to 2 wt %.

13. The aqueous polymer dispersion as claimed in claim 1, wherein component A is present in an amount of 5.0 to 65.0 wt %.

14. The aqueous polymer dispersion as claimed in claim 1, wherein component A is present in an amount of 30.0 to 60.0 wt %.
